(19) United States
(12) Patent Application Publication
(10) Pub. No.: US 2012/0141947 A1
(43) Pub. Date: Jun. 7, 2012

(54) METHOD FOR CONVEYING HYDROCARBONACEOUS MATERIAL

(76) Inventor: Todd C. DANA, Park City, UT (US)

(21) Appl. No.: 13/348,535

(22) Filed: Jan. 11, 2012

Related U.S. Application Data
(63) Continuation-in-part of application No. 13/070,334, filed on Mar. 23, 2011.
(60) Provisional application No. 61/316,748, filed on Mar. 23, 2010.

(51) Int. Cl. F27D 99/00

(52) U.S. Cl. 432/5

(57) ABSTRACT

A method of heating and conveying hydrocarbonaceous material in a retort structure having an internal volume, an outlet, a grate, a gas injector, and an auger. In the method the hydrocarbonaceous material is introduced into the internal volume through the inlet. The inlet substantially prevents gaseous transfer between the inner volume and the exterior of the retort structure. The hydrocarbonaceous material is passed through the grate. A gas heated to a first temperature is injected through the gas injector to heat the hydrocarbonaceous material while the hydrocarbonaceous material is atop the grate. The hydrocarbonaceous material is collected after passing through the grate. The hydrocarbonaceous material is then removed through the outlet.

This application is a continuation-in-part of U.S. patent application Ser. No. 13/070,334 filed on Mar. 23, 2011. U.S. patent application Ser. No. 13/070,334 claims the benefit of and priority from U.S. Provisional Patent Application No. 61/316,748 filed on Mar. 23, 2010. Both of these applications are hereby incorporated in their entirety for all purposes by this reference.

### FIELD

Embodiments of the invention relate generally to extraction of hydrocarbons from materials having organic components and, more specifically, to the conveying of materials through a retort structure in a substantially continuous process.

### BACKGROUND

Billions of barrels of oil can be found in oil shale, coal, lignite, tar sands, animal waste and biomass around the world. Yet an economically viable, easily scalable hydrocarbon extraction process has not, to date, been developed. Few, if any, extraction processes are in commercial use without government subsidies. Throughout the history of unconventional fuel extraction by pyrolysis, various types of retorting processes have been used, but in general, there are similar genres for these processes. The genres of technologies have generally been categorized as i) above-ground retorts, ii) in-situ processes, iii) modified in-situ processes, and iv) above-ground capsulation processes. Each genre exhibits specific benefits but also exhibits associated problems that preclude successful commercial implementation.

### Above-Ground Retorts

Above-ground retorts in the form of fabricated vessels exist in many sizes, shapes, and designs, with each offering various attributes in terms of throughput, heat recovery, heat source type, and horizontal or vertical engineering. Technologies for above-ground retorting include, but are not limited to, plants and facility designs such as those of Petrosix, Fushun, Parahoe, Kiviter and the Alberta Taciuk Process (ATP). In general, all of these processes are examples of above-ground, fabricated steel retorts which move heated carbonaceous material through the retort.

Success of conventional, above-ground retorting has been severely limited due to economic factors. Among the many economic considerations precluding successful commercialization, is the cost of fabrication of the retort, which requires large volumes of steel and complex forming and welding. This is further compounded by the need to construct ever-larger retorts to handle a sufficiently large feedstock ore of hydrocarbonaceous material (such as oil shale) volume to achieve hydrocarbon production on a large-enough scale to justify transportation (pipeline) infrastructure leading to a refinery, or a refinery on site. Furthermore, as the size of a retort is increased, significant material handling problems reduce the benefits provided by the large-scale production.

In view of these constraints, the conventional wisdom is that in order to obtain the throughput required for economical production, one must move the feedstock ore through the retort as quickly as possible. However, increasing the rate at which feedstock ore is processed requires an increase in heat rate of the feedstock and, therefore, the temperature of the overall retort process. Yet, by going to a higher retorting temperature, the quality of the produced hydrocarbons decreases, and the higher temperature creates a substantially higher volume of emissions than is desirable, or even permissible under ever-more-restrictive government regulations. Further contributing to the problems of rapid processing at high temperature, the cost of heating the feedstock ore compels the recovery of energy from the feedstock ore prior to discharge from the retort for the process to be economically feasible at higher temperatures. These energy input and recovery problems with conventional retort-based technology are directly related to its poor economic performance.

Economically and practically speaking, an above-ground steel retort is limited in size due to cost and difficulties in fabrication of a large retort vessel and the required support structure. Additionally, even were it economically feasible to fabricate a large retort structure, material handling problems limit the benefit obtained from a large retort structure. Thus, in order to achieve an economically viable production volume, the limited size of above-ground retorts requires a short heating residence time within and a faster, higher heat rate. However, as noted, the retort then yields a lower quality oil and poses greater heat recovery challenge.

Further to the challenge is the economy and efficiency of scale in production and processing. For example, several of the largest oil shale retorts in the world including the Stuart Shale Project, the Parahoe, the ATP, and the PetroSix, each produce less than 5,000 barrels (bbl) per day. Some of these have never run at steady state or anywhere even near this cited volume. Relative to large oil wells and relative to the capital for these wells, oil shale and coal retorting becomes unattractive economically given the low volume output juxtaposed by the high capital cost. Furthermore, most liquids from pyrolysis require the additional processing step of hydrotreating to remove arsenic, nitrogen and other undesirable chemical attributes in oil. But because of the economy of scale issue also impacting the capital cost and operating cost of hydrotreating plants necessary to remove nitrogen, add hydrogen and remove arsenic, these facilities also depend on an oil feedstock rate in quantities of at least 20,000 bbls per day to justify the construction of these multi-hundred million dollar facilities. Accordingly, great volume to justify costs in the upstream production (pyrolysis) and the downstream processing (hydrotreating) are needed and each problem depends on the upstream retorting volumes of a given extraction process.

### In-Situ Processes

Difficulties relative to limited retort volume from above-ground retort feedstock ore processing gave rise to the concept and development of leaving such hydrocarbonaceous material in place and heating it in formation, such processes being known as “in-situ processes” and “modified in-situ processes.” The concept of in-situ processes is based on the assumption that by forgoing the mining and handling of feedstock ore in favor of drilling through the formation comprising the hydrocarbonaceous material, you can reduce costs by introducing heat directly into the formation through bore holes to extract hydrocarbon liquids. The logic seems simple and, therefore, sounds like a good idea on paper. Thus, there have emerged many conceptual approaches to introduce heat below ground by drilling a well pattern in the ground and, in some cases, using so-called “intelligent” geometric spacing in an attempt to efficiently add heat or remove gas and liquids.

In-situ processes, while thermally and economically promising in theory, suffer in practice from an undeniable, industry-blocking problem in the form of their inability to effectively protect subterranean hydrology proximate the production area following in-situ heating. It is becoming more appreciated with the passage of time and increase in demand due to residential, agricultural, commercial, and industrial development that the one natural resource which is more valuable than crude oil is fresh ground water. For example, in oil shale-rich regions around the world—particularly in the Western United States as well as in the deserts of Australia, Jordan, and Morocco—fresh water is in limited supply. In some cases, such as in Colorado's Piceance Basin, the oil shale formation is in direct contact, both above and below, with the fresh water runoff from the Rocky Mountains.

In recent years several technologies have made progress relating to in-situ recovery, but none have come up with a 100% effective solution for protecting ground water following in-situ extraction processes. Even with the advent of Royal Dutch Shell's so-called “freeze wall” technology to solidify moisture in-situ surrounding the process area to protect ground water before and during operation of Shell's in-situ process, Shell has not and cannot provide assurance that ground water contamination will not occur after the freeze wall is allowed to thaw. Over time, ground water returns to the formation containing the post-processed materials and then interacts with the formerly heated zones which still contain remaining volatile organic compounds which will then proceed to migrate and eventually contaminate rivers and streams in the area. Confidence related to hydrology protection is, therefore, needed long after heating of a formation by an in-situ technology. This environmental confidence will only come with the engineered isolation of spent hydrocarbons and ground water, which in-situ processes have been unable to provide.

Another aspect of concern related to in-situ processes is lack of predictability of the overall recovery rate of hydrocarbons from the oil shale or other hydrocarbonaceous material, such as coal, originally in place within the formation. Because in-situ technologies depend on heat introduction methods which hopefully coax hydrocarbons to emerge from production wells, and because subterranean formations are complicated geological structures, there can be no true certainty as to overall recovery rate from an in-situ treated formation. In the case of governments and other entities which lease mineral rights to oil shale or coal producers using such technologies, because royalties paid them are directly related to the overall recovery rate (in terms of volume recovered) of the hydrocarbons in place, recovery in terms of percentage yield of hydrocarbons in place is important.

### Modified In-Situ Processes

There are many so-called modified in-situ processes employing blasting and even vertical columns in the ground; however, none of these approaches utilize a permeability control infrastructure to collect hydrocarbons or to segregate the rubble zones from the adjacent formation. In other words, a selected portion or a formation containing organic materials is drilled and blasted to create a “rubbleized” area, which may comprise a vertical rubble column. In-situ application of heat to, and extraction and collection of hydrocarbons from, the rubbleized material is then effected as described above with respect to traditional in-situ processes.

Both in-situ and modified in-situ hydrocarbon extraction processes may be characterized as “batch” processes, in that organic material containing extractable hydrocarbons is processed in place, i.e., at its site of origin. Therefore, all of the associated infrastructure required for heating the organic material and extracting and collecting hydrocarbons therefrom must be built on site, or transported to the site, and is either left on-site (as in the case of underground components) or, if not worn out during the extraction and collection process, transported to another site for re-use.

### In Capsule Technology

The in capsule extraction process generally relates to the batch extraction of liquid hydrocarbons from hydrocarbonaceous material in the form of a feedstock ore body contained in an earthen impoundment. Relevant to this process are the aspects of heating the impounded hydrocarbonaceous material in place while it is substantially stationary.

Stationary extraction of hydrocarbons is problematic for several reasons. First, the aspect of the feedstock ore remaining substantially stationary (allowing for only ore movement in the form of vertical subsidence during heating), entails a single use, batch impoundment which is processed until the yield of liquid and volatile hydrocarbons decreases to a point where cost/benefit of energy input to hydrocarbon yield dictates termination of the operation. These impoundments may be envisioned as an array or pattern of very large (in terms of length and width), one use, spread out pads of feedstock ore just below the earth's surface, similar to ore pads employed in a heap leaching process in mining. The width of each such ore pad requires a superimposed vapor barrier to contain hydrocarbon volatiles released during the heating of the feedstock ore to be formed directly on top of, and supported by, the ore body being heated as no structural steel or other separate vapor barrier support span is economically feasible. Thus, the only feasible option of resting the vapor barrier on top of the feedstock ore subjects the vapor barrier to subsidence of the ore as liquid and volatile hydrocarbons are removed.

As subsidence occurs, cracking of the vapor barrier resting on top of the heap also occurs. Further to the problem is that integrity of a clay impoundment barrier such as is designed to prevent release of the hydrocarbon volatiles (i.e., as a vapor barrier), is dependent on retained moisture which is driven off by the process heat. So, as heating occurs over time, not only does subsidence of the feedstock ore increase, but at the same time the clay impoundment dries, until the lack of underlying support of the clay impoundment in combination with its drying and associated loss of both flexibility and impermeability to hydrocarbon volatiles results in cracking as well as increased porosity. While a polymeric liner may be employed with a clay impoundment vapor barrier to stop vapor leakage through cracks in the clay caused by subsidence, the high temperature of gases escaping through the cracks in the clay will result in contact of the gases with any such liner. At the high process temperatures employed, the liner will likely melt, compromising its integrity. Vapor barrier compromise is a major problem and results in subsidence that is highly detrimental to the economics of hydrocarbon recovery, as well as protection of the ambient environment. In such cases, given the vapor production of pyrolysis which is known, a significant percentage of the potentially recoverable hydrocarbons may be lost as escaped volatiles which also contaminate the atmosphere.

The problem of subsidence of the feedstock ore body also gives rise to other problems associated with operation of the in capsule extraction process. Subsidence may exhibit such a great problem over time that horizontal pipes used to heat the ore body must be protected by significant preplanning to adjust for the sinking of the pipes during heating. In addition, heater pipe penetration joints may be required to anticipate and attempt to mitigate the subsidence issue as a cause of heater pipe collapse and bending under the force of a subsiding ore body above them. It has been proposed to employ corrugated metal pipe as a means to provide heater pipe flexure in tandem with the collapse of the subsiding ore body so as avoid heating pipe breakage. However, none of the foregoing techniques can be used to address heat-induced subsidence, sinking, cracking and integrity compromise or a vapor barrier supported by the impounded feedstock ore body.

The cost to create permeability control infrastructures for each impounded feedstock ore body is another problem from which the in capsule extraction process suffers. Because the in capsule extraction process is applied to an ore body impoundment, there is no “throughput” of the hydrocarbonaceous materials whatsoever, but instead as a batch process requires a new containment barrier for every single batch processed. With substantial preparation and earth work related to clay impoundments or other control liners necessary before hydrocarbons can be extracted from each impounded ore body, the cost of creating an entirely new barrier becomes prohibitive. The in capsule extraction process also entails a heat up period that is costly in terms of energy input and time waiting for heat up to produce a high enough temperature in the ore body for hydrocarbon recovery to commence.

Therefore, because of the problem of barrier cracking as a result of subsidence, the problem of cost associated with continuous barrier and impoundment construction, and because of the heat up requirement of time and energy for each batch, a better, new invention for controlling vapor without risk of barrier cracking and without high cost of barrier construction is needed.

While it should be readily apparent, a disadvantage of any batch-type hydrocarbon extraction process, be it in-situ, modified in-situ or in capsule, is the batch production of the extracted liquid hydrocarbons. When such processes result in production after a period of heating, the large volume of the extracted liquid hydrocarbons produced over a relatively short period of time requires either immediate access to a pipeline for transportation to a refinery or a large storage tank volume, in either case driving up the cost of such an installation.

### SUMMARY

Embodiments of the invention include a method of heating and conveying hydrocarbonaceous material in a retort structure. The retort structure comprises an internal volume, an outlet, a grate, a gas injector, and an auger. The method includes introducing the hydrocarbonaceous material into the internal volume through the inlet. The inlet substantially prevents gaseous transfer between the inner volume and the exterior of the retort structure. The hydrocarbonaceous material is passed through the grate. A gas heated to a first temperature is injected through the gas injector to heat the hydrocarbonaceous material while the hydrocarbonaceous material is atop the grate. The hydrocarbonaceous material is collected with the auger after the hydrocarbonaceous material has passed through the grate. The hydrocarbonaceous material collected by the auger is then removed through the outlet. The outlet substantially prevents gaseous transfer between the inner volume and the exterior of the retort.

In some embodiments passing the hydrocarbonaceous material through the grate comprises raking a top of the grate to push hydrocarbonaceous material into an open portion of the grate. The hydrocarbonaceous material above the grate may be distributed with a second auger. The hydrocarbonaceous material may be caught on the second grate after the hydrocarbonaceous material passes through the first grate and then passed through the second grate. A second gas at a second temperature may be injected into the hydrocarbonaceous material atop the second grate.

The hydrocarbonaceous material may travel from the inlet through the grate and from the grate through the outlet through the force of gravity. The top of the second grate may be raked pushing hydrocarbonaceous material into an open portion of the second grate.

A method of heating and conveying a hydrocarbonaceous material through a retort structure is disclosed in another embodiment. The method includes introducing the hydrocarbonaceous material through an inlet to the retort structure, wherein the inlet substantially prevents gaseous transfer from the interior of the retort structure and an exterior of the retort structure. A first pile of hydrocarbonaceous material is formed atop a first grate. A first gas at a first temperature is injected into the pile of hydrocarbonaceous material formed atop the first grate. A lower portion of the first pile of hydrocarbonaceous material is raked into an open portion of the first grate. A second pile of the hydrocarbonaceous material is formed atop a second grate, the second pile being comprised of hydrocarbonaceous material fallen through the first grate. A second gas at a second temperature is injected into the second pile of hydrocarbonaceous material formed atop the second grate. A lower portion of the second pile of hydrocarbonaceous material is raked into an open portion of the second grate. The hydrocarbonaceous material fallen through the second grate is then collected with an auger. The hydrocarbonaceous material is then removed through the outlet, wherein the outlet inhibits gaseous transfer between the interior of the retort structure and its exterior.

The first temperature may be between 600 and 900 degrees Fahrenheit. The second temperature may be is between 220 and 400 degrees Fahrenheit. The second gas may be steam. The hydrocarbonaceous material may be introduced into the retort structure at a rate exceeding 25000 tons per day. The hydrocarbonaceous material may be heated to a temperature less than 800 degrees Fahrenheit atop the first grid. The hydrocarbonaceous material may be cooled at the second grid to a temperature less than 300 degrees Fahrenheit. The removed hydrocarbonaceous material may be quenched in a quench chamber. The quenching process may generate steam which may be used to power an auxiliary process.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a cutaway perspective view of a retort structure.

FIG. 2 is a cutaway orthogonal view of the retort structure of FIG. 1.

FIG. 3 is a cutaway perspective view of a vapor sealed lock hopper.

FIG. 4 is a perspective view of a distribution system within the retort structure of FIG. 1.

FIG. 5 is a perspective view of a grate assembly and rake assembly of the distribution system of FIG. 4.

FIG. 6 is a perspective view of the gas distribution lines of the distribution system of FIG. 4.

FIG. 7 is a perspective view of a wedge covering a gas distribution line of the distribution system of FIG. 4.

FIG. 8 is an orthogonal view of the interior of the retort structure of FIG. 1 looking downward at the floor assembly.

FIG. 9 is a cut away orthogonal view of the collection system the retort structure of FIG. 1.

The drawings are not necessarily to scale.

### DETAILED DESCRIPTION

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Detailed Description does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

Throughout the description reference will be made to a retort structure. A retort structure is defined as a structure enclosing a mass of heated material in which a retort process occurs.

Throughout the description, reference will be made to a vapor seal. A vapor seal is defined as a barrier that substantially inhibits air, moisture, and/or contaminants from migrating through the barrier. Examples of vapor sealed barriers include non-porous walls, impermeable coatings, impermeable liners, and similar components. A mechanical component is considered to be vapor sealed if it is capable of substantially inhibiting air, moisture, and/or contaminants from migrating through the mechanical component.

Throughout the description, reference will be made to organic material. In the context of this application, organic material is defined as material having an organic component. For example, oil shale has organic kerogen and is therefore considered an organic material. The term hydrocarbonaceous material refers to a material containing hydrocarbons. Hydrocarbonaceous materials fall within the category of organic material.

Throughout this application, reference will be made to high temperature. A temperature is considered to be a high temperature if it exceeds 500 degrees Fahrenheit.

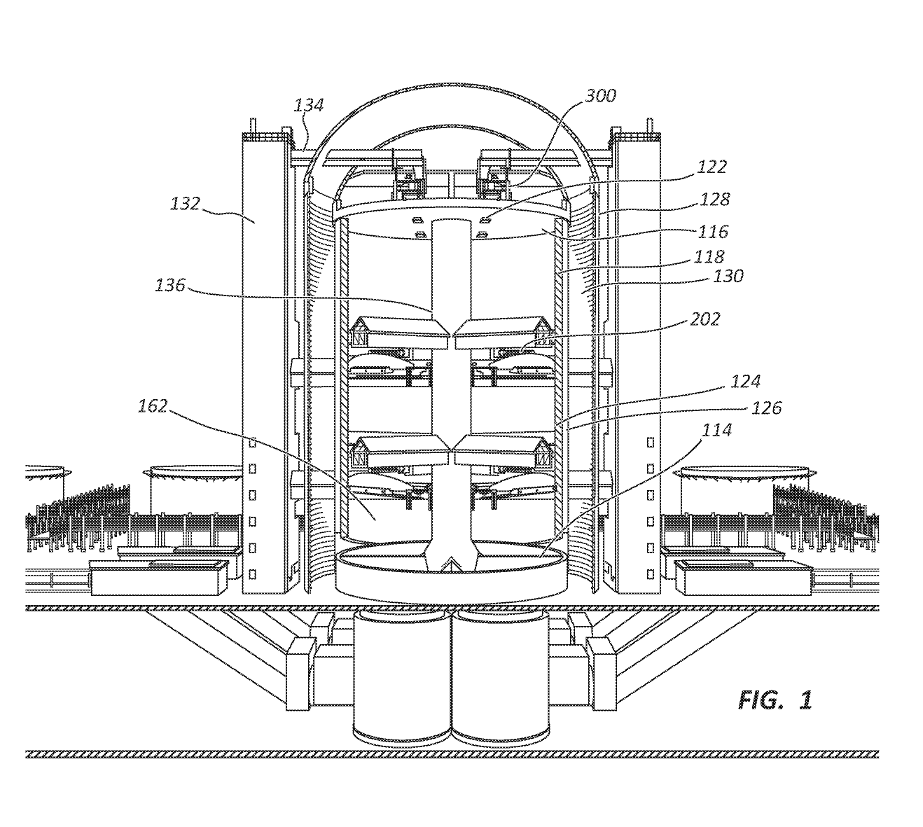

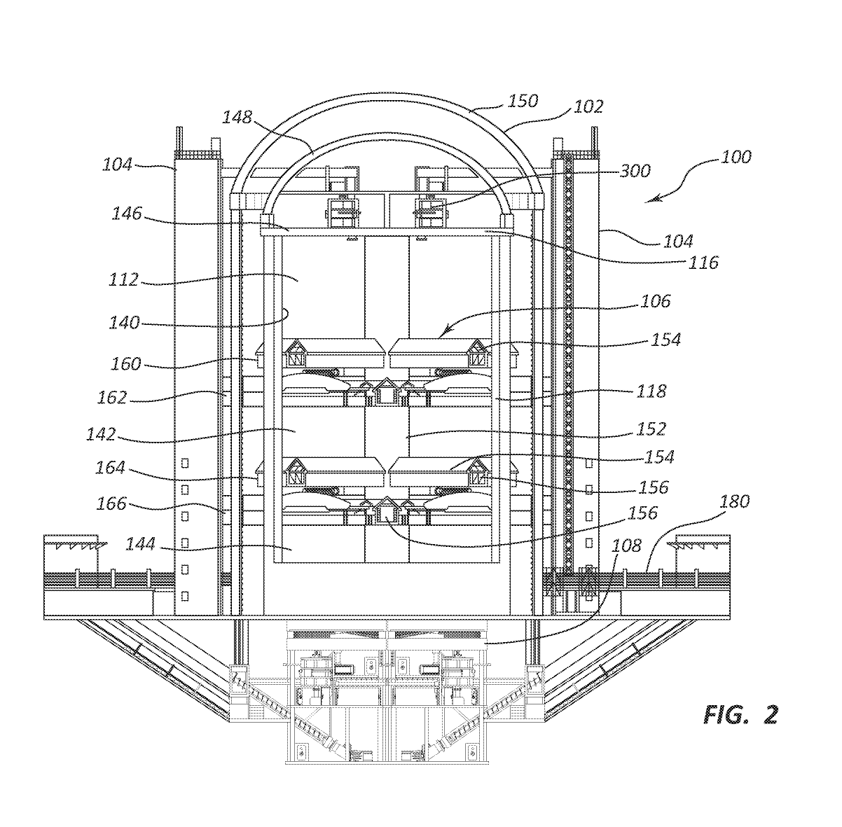

FIG. 1 is a perspective cross-section of a retort system 100. FIG. 2 is an orthogonal cross section of the retort system of FIG. 1. The retort system 100 generally comprises a retort structure 102, a feed system 104, a distribution system 106, and an oil collection system 108. Each of these structures and system will be described in greater detail below. In normal operation, material such as an organic material undergoing pyrolysis would be present in the retort structure 102. For sake of clarity, the material will not be shown in the drawings.

The retort structure 102 is designed to be operated at a high temperature and encloses an inner volume 112. The inner volume 112 is divided into zones which have different operating temperatures and contain material in different states. For example, the inner volume 112 of the embodiment of FIG. 1 has an upper zone 140, a middle zone 142, and a lower zone 144. In this embodiment, the upper zone 140 contains material that has not reached a pyrolysis temperature, the middle zone 142 contains material that has reached the pyrolysis temperature, and the lower zone 144 contains material cooled below the pyrolysis temperature. In other embodiments other numbers and configurations of zones are possible, such as a preheat zone containing material being preheated.

The retort structure 102 is comprised of a floor assembly 114, a ceiling assembly 116, a wall assembly 118, and a bridge assembly 136. The retort structure 102 is depicted as being substantially cylindrical in shape such that the wall assembly 118 encompass a circular shape having an inside diameter 120. In other embodiments other configurations are possible such at the dome of U.S. patent application Ser. No. 13/070,334. The retort structure 102 defined by the wall assembly 118, ceiling assembly 116, and floor assembly 114 may have a dimension, by way of example, of from 10 to 400 feet in diameter and up to greater than 200 feet in height.

The floor assembly 114 forms a lower boundary of the inner volume 112. The floor assembly 114 is comprised of a material resistant to heat such as a cementatious material having at least 5 percent igneous material by weight or steel or steel alloys. In some embodiments, the floor assembly 114 may be comprised of layers of materials that may be different in composition from one another. The floor assembly 114 has at least one discharge opening (not shown) through which material can be discharged. The embodiment depicted in FIG. 1 has four discharge openings, although other numbers of discharge openings are possible.

The ceiling assembly 116 of the retort structure 102 forms an upper boundary of the inner volume 112. In the embodiment of FIG. 1, the ceiling assembly is comprised of three separate layers. An inner layer 146 forms the boundary with the inner volume 112, an inner dome layer 148 covers the inner layer 146, and an outer dome layer 150 forms a vapor seal over the inner dome layer 148. The ceiling assembly 116 has at least one intake opening 122 through which material can be introduced into the inner volume 112. In the embodiment of FIG. 1, four intake openings 122 are depicted. Other numbers and configurations are possible. For example, a single intake opening 122 could be centrally located in the ceiling assembly 116.

The wall assembly 118 of the retort structure 102 forms a lateral boundary of the inner volume 112. The wall assembly 118 is formed of a series of layers. The inner layer 124 of the wall assembly 118 is formed of a high-temperature resistant fast curing material such as a quick curing, high-temperature cement or refractory material. One example of suitable cement is magnesium phosphate cement. The high temperature resistant fast curing material allows the inner layer 124 to be readily replaced during maintenance, while still being durable enough to withstand the high temperatures and abrasive nature of the material passing through the inner volume 112. In some embodiments the high temperature resistant fast curing material is durable enough to last at least a year before replacement.

An intermediate layer 126 of the wall assembly 118 is formed of a high temperature concrete or refractory material or combinations thereof. The intermediate layer 126 is disposed outside of the inner layer 124 and the inner layer 124 is physically attached to the intermediate layer 126. The concrete of the intermediate layer 126 does not need to be fast curing like the inner layer 124, as the intermediate layer 126 does not experience significant wear and therefore does not need to be replaced regularly. The intermediate layer 126 is self-supporting such that no bracing is needed external to the intermediate layer 126. The high temperature concrete of the intermediate layer 126 is of a concrete containing a material such as fly ash, igneous material, granite, sand, pozzolan, lava rock, ceramic material, cement, Portland cement, steel, nickel alloy steel, carbon, carbon black, spent shale, reef material, refractory clay, refractory gunnite, or magnesium phosphate.

In one embodiment, the intermediate layer 126 is monolithic in construction. The high temperature concrete is poured as a single continuous pour such that seams or cracks are substantially avoided or not present in the intermediate layer 126. The intermediate layer 126 may be internally reinforced using either pre stressed rebar or post stressed tension cable construction.

An outer permeability barrier layer 128 is disposed external to the intermediate layer 126 and the inner layer 124. Together with the outer dome layer 150 of the ceiling assembly 116, the outer permeability barrier layer 128 may substantially prevent gas from escaping from the retort structure 102. The outer permeability barrier layer 128 may be comprised of a steel material such as carbon steel, alloy steel, high temperature steel, rolled alloys, seam welded roll alloys, nickel steel alloy, rolled nickel steel alloy, and seam welded nickel steel alloy rolls. Other materials are suitable and in other embodiments aluminum, geodesic aluminum pieces, and other impermeable materials may be used.

In the embodiment of FIG. 1, a void 130 exists between the outer permeability barrier layer 128 and the intermediate layer 126. The void 130 is pressurized with an inert gas such as nitrogen or carbon dioxide. The nitrogen or carbon dioxide may be pressurized to a pressure higher than a pressure in the inner volume 112 of the retort structure 102. Having a pressure higher than the pressure of the inner volume 112 ensures that substantially any gas that permeates through the intermediate layer 126 and the inner layer 124 will flow into the inner volume 112. Thus, any gases produced within the inner volume 112 will remain within the inner volume 112 and any gas that enters the inner volume 112 through the wall assembly 118 will be inert. The void 130 between the intermediate layer 124 and the outer permeability barrier layer 128 additionally serves as insulation layer.

In some embodiments, the void 130 between the intermediate layer 124 and the outer permeability barrier layer 128 has a vacuum pulled on it such that there is little pressure within the void 130. The vacuum increases the insulative properties of the void 130, but does not address the issue of gasses permeating the inner layer 124 and the intermediate layer 126. In such an embodiment, the inner layer 124 and/or intermediate layer 126 may be treated to reduce their permeability. A sensor may be used within the void 130 to detect if gases from the inner volume 112 are present in the void 130 indicating a failure of the treatment of the inner layer 124 and/or intermediate layer 126.

The feed system 104 feeds material into the inner volume 112 of the retort structure 102. The feed system of FIG. 1 comprises a material conveyance mechanism or bucket elevator 132 which lifts the material from a lower level to an upper level of the retort structure 102. In some embodiments, the retort structure 102 may be at least partly subterranean such that the elevator 132 is not needed. In some embodiments, a material conveyer may transport the material in place of the elevator 132. The material elevator 132 may be substantially vapor sealed or overpressured or purged using inert gas such that oxygen does not pass through the elevator 132 into the retort structure 102.

At the upper end of the retort structure 102 a conduit 134 passes from the elevator 132 through the outer dome layer 150 and inner dome layer 148. The conduit 134 may have a conveyer located within to convey material from the elevator 132 through the outer dome layer 150 and inner dome layer 148. The conduit 134 may be pressurized with an inert gas to hinder the movement of oxygen from the elevator 132 through the conduit 134 into the retort structure 102.

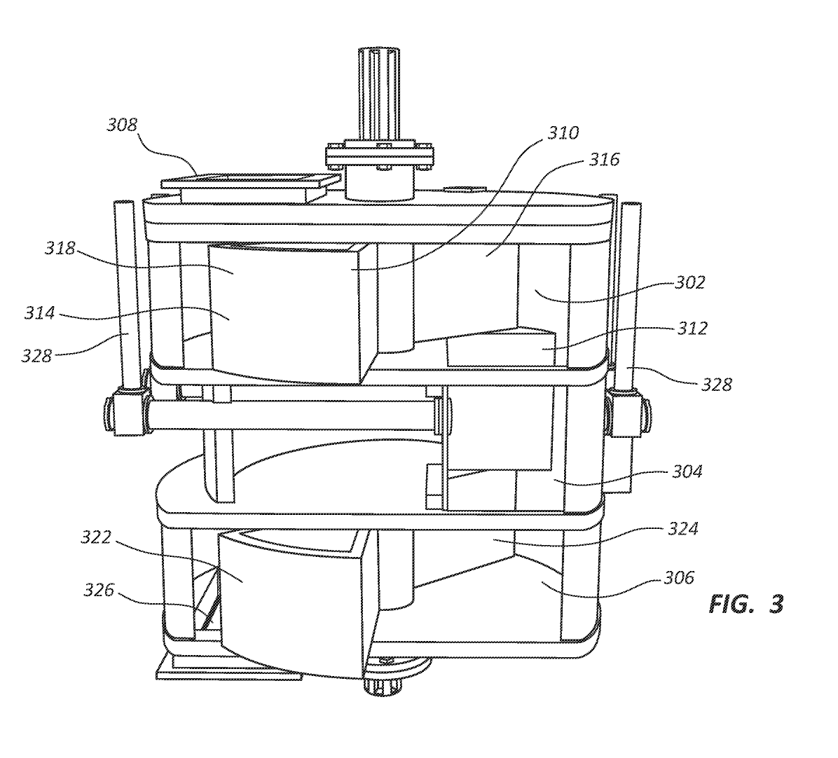

Within a volume between the inner dome layer 148 and the inner layer 146 of the ceiling assembly 116, a gas sealed lock hopper 300 is disposed to transport material from the conduit 134 through the inner ceiling layer 146 and into the inner volume 112 through the intake opening to substantially restrict oxygen from being introduced to the retort structure 102. The gas sealed lock hopper 300 will be described in greater detail in relation to FIG. 3.

The gas sealed lock hopper 300 has an upper intake section 302, a middle pressurized section 304, and a lower exit section 306. An intake 308 connects the upper intake section 302 to a feed source such as the conduit 134 of FIG. 1. An intake exit 312 connects the upper intake section 302 and the middle pressurized section 304. An upper insert 310 is disposed within the upper intake section 302 and is adapted to be translated from a first position 314 in line with the intake 308, and a second position 316 in line with the intake exit 312. The upper insert 310 has side walls 318 providing a lateral boundary, but no top walls or bottom walls.

In operation, at the first position 314 material is delivered through the intake 308 and falls into the insert upper insert 310. A floor 320 of the intake section 302 prevents the material from falling past the upper insert 310. The upper insert 310 is then translated to the second position 316 in line with the intake exit 312 thereby moving the material within the upper insert 310. The floor 320 no longer prevents the material from falling from the upper insert 310 and the material falls through the middle pressurized section 304 through the intake exit 312.

The lower exit section 306 has a lower intake 324 and an exit 326. A lower insert 322 aligns with the lower intake 324 and receives the material that falls through the middle pressurized section 304. The lower insert 322 is then translated such that the lower insert 322 aligns with the exit 326 and the material is able to exit the gas sealed lock hopper 300 into the inner volume 118 while limiting or substantially restricting oxygen entering into the retort structure 102.

The middle pressurized section 304 is pressurized with an inert gas delivered through gas pipes 328. The elevated pressure of the inert gas causes the inert gas to inhibit the flow of other gases through the gas sealed hopper 300. Thus gas is inhibited from traveling from the inner volume 112 to the conduit 134, or from the conduit 134 to the inner volume 112. Alternatively, inert gases could be introduced in either of the upper or lower chambers of the gas sealed hopper 300 in a manner that reduces, restricts or substantially eliminates oxygen from entering the retort structure 102.

Returning to FIGS. 1 and 2, the bridge assembly 136 comprises a central column 152 extending from the floor assembly 114 to the ceiling assembly 118. In some embodiments, the bridge assembly 136 may support the ceiling assembly 118. A plurality of bridges 154 extends from the central column 152 towards the wall assembly 118. Each bridge 154 may have an internal passageway 156 extending from the wall assembly 118 to the central column 152. In some embodiments, the internal passageway 156 extends partially between the wall assembly 118 and the central column 152. The internal passageway 156 may be sealed such that an environment within the internal passageway 156 is isolated from the environment of the inner volume 112. The internal passageway 156 may be insulated such that the temperature within the internal passageway 156 can be maintained separate from the temperature of the inner volume 112. The internal passageway 156 may house gas piping for the transport of heating gases. In some embodiments, the internal passageway 156 may be actively cooled to keep its temperature lower than that of the inner volume 112. The active cooling may comprise a cooling fluid passing through the bridge 154. The internal passageway 156 may be purged with an inert gas such that any gas escaping to the inner volume 112 of the retort structure 102 is inert. In some embodiments the roof of a bridge assembly 136 may have a vibration mechanism to assist the flow of hydro carbonaceous material by vibration advancing the material through the retort structure 102 by gravity, or have dual wall chambers to introduce liquid or inert gas cooling.

Each bridge 154 of the bridge assembly 136 may have a different configuration. For example, the bridges 154 could include a heated gas delivery bridge and a personnel access bridge. The functionality of the bridges 154 can be combined, such as a bridge 154 having both a mechanism for heated gas delivery, liquid collection, temperature monitoring, thermocouple disposition or personnel access.

The bridges 154 are arranged in layers and each layer may have a different function. The bridges 154 of FIG. 1 are arranged in a first layer 158, a second layer 160, a third layer 162, and a fourth layer 164. In For example, the second layer 160 of bridges 154 may supply heated gas to the inner volume 112, while the fourth layer 166 of bridges 154 of gas may supply cooling gas to the inner volume 112.

The bridges 154 may extend past the wall assembly 118. For example, the first layer 160 and third layer 164 of bridges 154 of FIG. 1 extend past the inner layer 124 and the intermediate layer 126. The second layer 162 and the forth layer 164 extend through the entire wall assembly 118. Extending the bridges 154 through the wall assembly 118 enables access to the inner volume through a mechanism other than the feed system 104 and collection system 108.

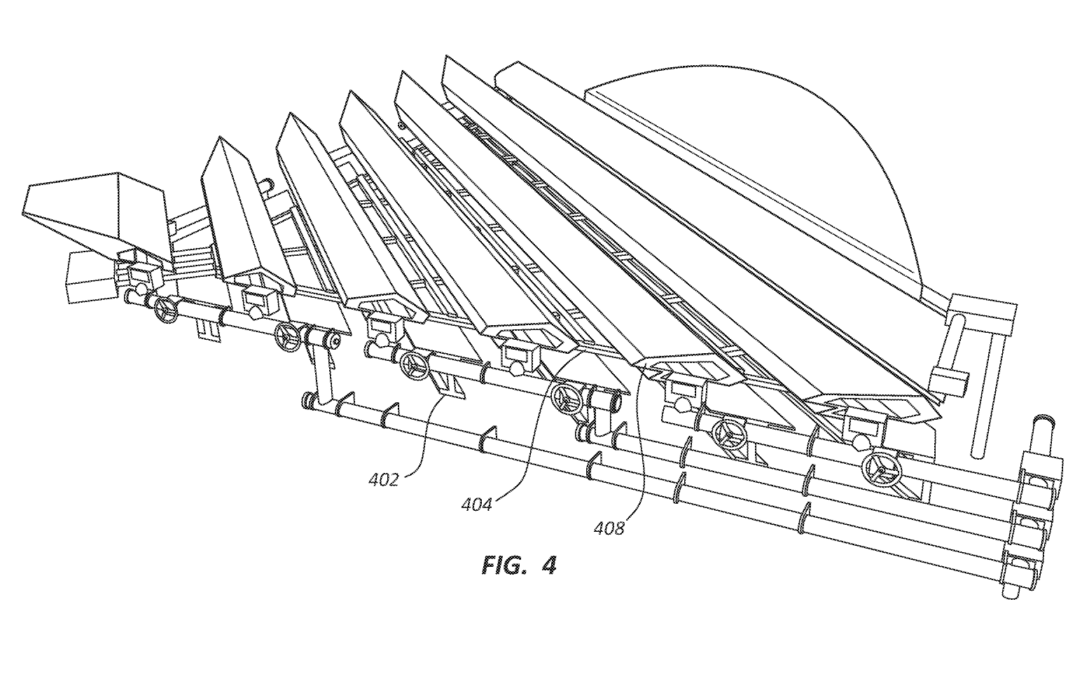

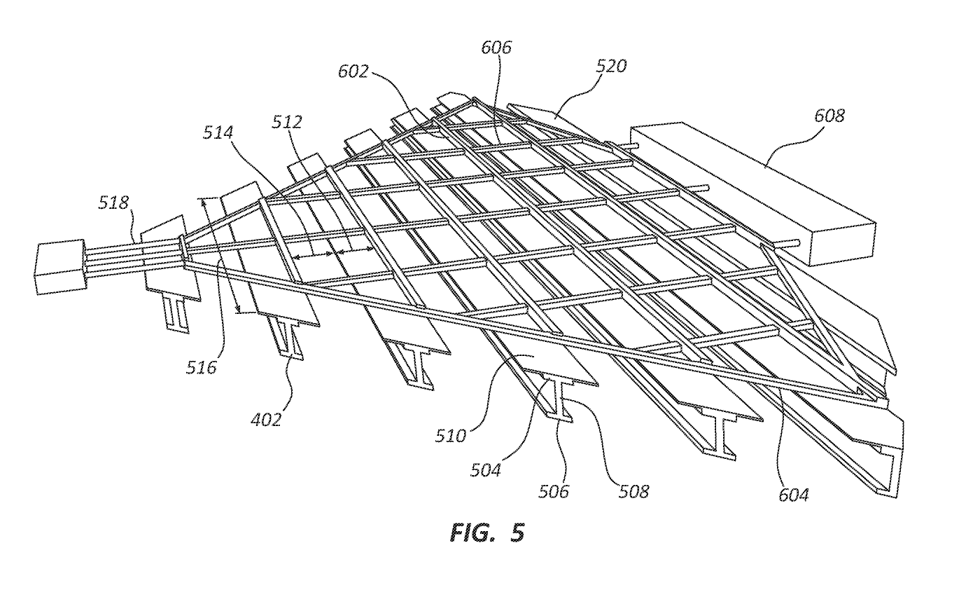

The bridges 154 support the distribution system 106 as shown in FIGS. 4 through 7. The distribution system 106 is comprises of distribution assemblies 400. In FIG. 4, a complete distribution assembly 400 is shown. The distribution assembly 400 comprises support beams 402, a rake 404, gas distribution lines 406, wedges 408, and nozzles 410. In the distribution assembly 400 the support beams 402 extend from one bridge 154 to another bridge 154. The rake 404 is disposed above the support beams 402 and removes material deposited on the support beams 402. The rake 404 is supported by the support beams 402 and may rest on the support beams 402. The gas distribution lines 406 are protected by the bridges 154 and extend across the distribution assembly 400 generally parallel to the support beams 402. A portion of the gas distribution lines 406 extending across the distribution assembly 400 is covered by the wedges 408 so that material does not contact the gas distribution lines 406. Nozzles are connected to the gas distribution lines 406 and are topped by the wedges 408. Each of these components and their relationships to one another will be described with reference to FIGS. 5 to 7.

In FIG. 5, the support beams 402 and the rake 404 are shown isolated for clarity. Normally a bridge 154 would be present at each end of the support beams 402 and would support the beams 402. The support beams 402 are generally aligned so that they form chords of a circle having a center at the central column 152. The support beams 402 of FIG. 5 are I-beams having an upper flange 504 and a lower flange 506 connected by a web 508. On top of the upper flange 504 is a table 510 that is disposed over the upper flange 504. In some embodiments, the upper flange 504 may form the table 510. A width 512 of the table 510 and a distance 514 between adjacent tables 510 is constant in FIG. 5 but need not be. In some embodiments, the tables 510 may have varying widths 512 and in some embodiments, the distance 514 between tables 510 may vary. Because the support beams 402 extend from one bridge 154 to an adjacent bridge 154, a length 516 of the support beams 402 increases from an inner beam 518 to an outer beam 520.

Other support beam 402 configurations are possible and the configuration of FIG. 5 is not limiting. For example, the support beams 402 could be circular extending in a circumferential direction. In other embodiments the support beams 402 may be angled such that they do not form chords or may be supported by a perimeter retort structure wall. In still other embodiments, multiple intersecting support beams 402 may be used.

The rake 404 is adapted to scrape material off of the support beams 402. The perimeter 604 of the rake 404 is complementary to that of the support beams 402. The rake 404 comprises scraper blades 602 that generally align with a support beam 402 disposed below the scraper blade 602 and may rest on the scraper blade 602. The scraper blades 602 are connected to one another by a plurality of studs 606. The studs 606 provide for lateral strength of the scraper blades 602 and enable the rake 404 to move as a single unit. An actuating mechanism 608 is adapted to move the rake 404.

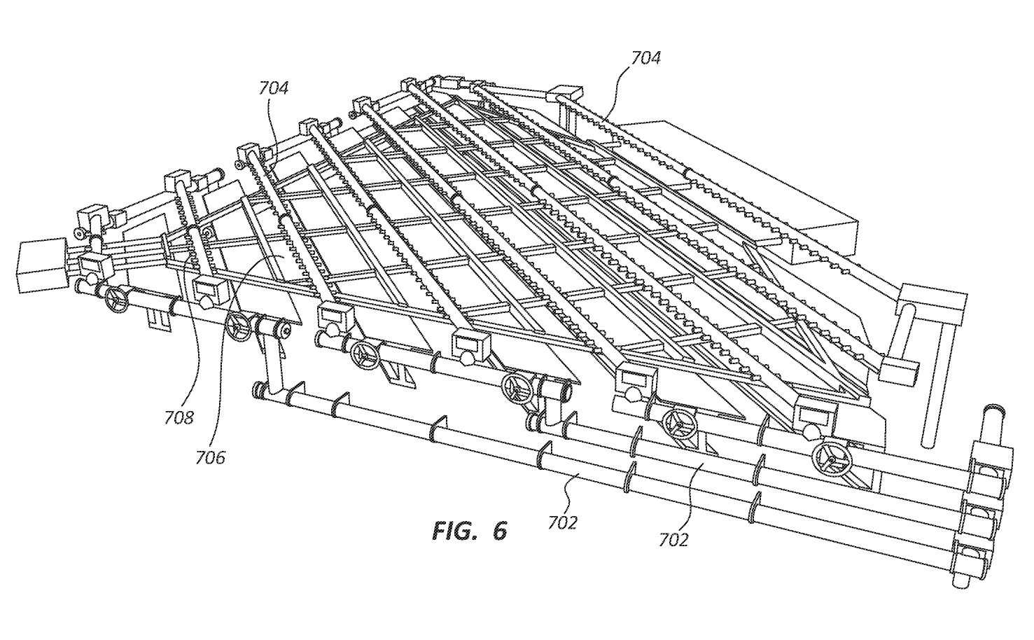

The actuating mechanism 608 may be a pneumatic cylinder, a hydraulic cylinder, a linear actuator, or some other mechanism adapted to provide movement to the rake 404. While the actuating mechanism 608 of FIG. 6 is depicted at the outer end of the rake 404, the actuating mechanism 608 could be located elsewhere, such as the inner end of the rake 404. The rate at which the rake 404 reciprocates back and forth, clearing the support beams 402 will affect the rate at which material passes through the distribution mechanism 400. The more often the rakes 404 scape the support beams 402, the faster the material will move through the distribution mechanism 400.

FIG. 6 depicts the gas distribution lines 406 that inject gas at a controlled temperature into the inner volume 112. The main branch of the gas line 702 is housed within the bridge 154 and secondary lines 704 run from one bridge 154 to another bridge 154 generally parallel to the support beams 402. The secondary lines 704 are disposed above a space 706 between each of the support beams 402. The secondary lines 704 have nozzles 708 that direct the gas horizontally from the secondary lines 704.

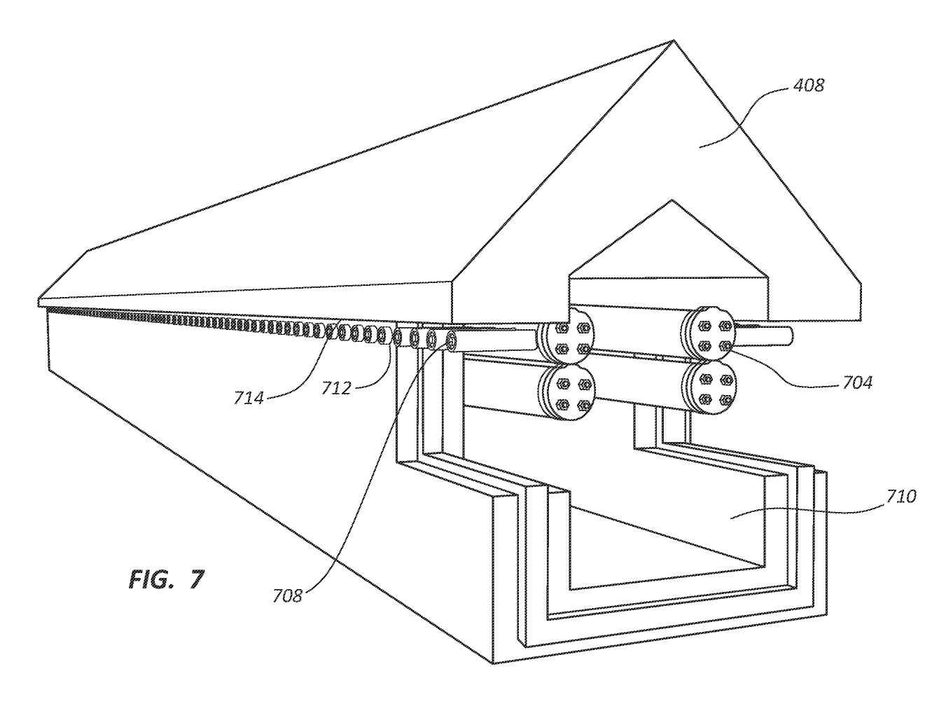

FIG. 7 illustrates a cut away view of a wedge 408. The wedges 408 are shown disposed about the secondary lines 704. The wedges 408 protect the secondary lines 704 and direct material to the tables 510. The wedges 408 have an internal cavity 710 through which the secondary gas lines 704 pass. The wedges 408 have a series of openings 712 through which the nozzles 708 exit the wedges 408. The wedges 408 have a ledge 714 disposed above the gas injection nozzles 708 that protects the gas injection nozzles 708 from the weight of the material disposed above the nozzle 708. The distance of spacing between the wedges 408 to an adjacent wedge 408 may be altered relative to the desired flow rate of hydrocarbon material, the gas pressure, temperature, or injection rate derived from gas through the gas injection nozzles 708, gas temperature from gas injection nozzle 708, desired pyrolysis recovery yields from material by passing the wedges 408, and particle size of the hydrocarbon material passing by wedges 408.

As can be seen in FIG. 1, the first layer 160 of bridges 154 is disposed above the second layer 162 of bridges 154 having distribution assemblies 400. The first layer 160 of bridges 154 is offset rotationally from the other bridges 154 such that they are disposed over the space between the individual bridges 154 of the second layer 162 of bridges 154. The first layer 160 of bridges 154 have augers 202 is disposed below them. The augers 202 are adapted to rotate about an auger 202 axis that is normal to the central axis of the retort and about a vertical axis such that the auger 202 is swept in a circular path. The machinery for driving the auger 202 may be disposed in the bridge 154 from which it is suspended and may be powered by high temperature resistant, pressurized hydraulic liquids. As the auger 202 turns about its axis it pushes or pulls material along its length. The auger 202 rotates in a horizontal plane and engages additional material as it rotates and material falls into the space left by the auger 202 as it rotates. In some embodiments auger 202 may have a direct conduit for discharge through a wedge 408 to bypass hydrocarbonaceous material to a lower level within the retort structure 102.

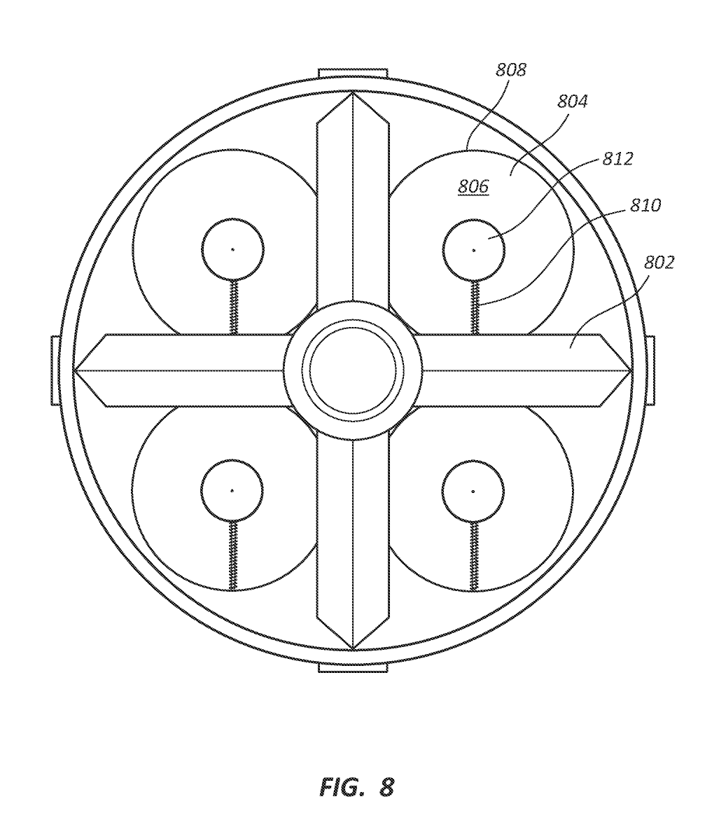

FIG. 8 depicts the floor assembly 114 of the retort structure 102 looking down through the retort structure 102. The oil collection system 108 is disposed proximate the floor assembly 114 and extends through the floor assembly 114. The oil collection system 108 illustrated in FIG. 8 is comprised of four separate oil collectors 804 that are substantially similar in function to one another. For the sake of brevity, the oil collection system 108 will be described in relation to a single oil collector 804. It will be noted that other quantities of oil collectors 804 are possible and that embodiments of the invention are not limited to this particular number of oil collectors 804.

The floor assembly 114 has a diverting structure 802 that directs the material into an oil collector 804. The oil collector 804 has a conical surface 806 with a slope sufficient to allow liquid hydrocarbons to flow down the conical surface 806 towards a perimeter 808 of the oil collector 804. The slope is typically between 1 and 5 degrees. If the slope is shallower than 1 degree the liquid hydrocarbons may not flow downward, but if the slope is greater than 5 degrees, material may flow down the conical surface 806 in addition to the liquid hydrocarbons. The conical surface 806 slopes from a region that is substantially central to the oil collector 804 toward the perimeter 808 of the oil collector 804. In some embodiments, the oil collector 804 may have a surface sloped differently, such as from the perimeter 808 down to a central region of the oil collector 804. The conical surface 806 has at least one baffle 812 on the sloped portion. The baffle 812 restricts the movement of the organic material down the conical surface 806 while allowing the liquid hydrocarbons to flow past the baffle 812. The baffles 812 may be placed perpendicular to the flow of the liquid hydrocarbons.

As shown in FIG. 8, an auger 810 is disposed proximate the conical surface 806 of the oil collector 804. The auger 810 extends from proximate the center of the oil collector 804 out to the perimeter 808 of the oil collector 804. The auger 810 has a longitudinal central axis that is substantially horizontal. The auger 810 is configured to rotate about the longitudinal central axis. The auger 810 is further configured to sweep about a substantially vertical axis that is substantially central to the oil collector 804.

As the auger 810 rotates about its longitudinal central axis, material proximate the auger 810 is conveyed in a direction generally parallel with the longitudinal central axis. The auger 810 has at least one helical flight that spirals about the longitudinal central axis. As the auger 810 rotates, material within the flights is pushed by the flights towards one end of the auger 810. The direction in which the material is pushed is dependent upon the configuration of the helical flights and the direction of rotation. In operation, the auger 810 is rotated such that material is pushed towards the center of the oil collector 804.

While the auger 810 rotates about its longitudinal central axis, the auger 810 is swept about the vertical axis, such that the auger 810 sweeps a circular path. As the auger 810 advances along the circular path material behind the auger 810 shifts downward to replace the space previously occupied by the auger 810 and material at the front edge of the auger 810 is swept towards the sweep axis. Thus, as the auger 810 sweeps a complete circle it will have engaged material substantially across the entire oil collector 804.

At the center of the oil collector 804 is an upper cone 812 that is disposed above the conical surface. The upper cone 812 protects the drive mechanism for the auger 810. An exit is disposed below the upper cone 812 such that material is able to exit the inner volume 112 of the retort structure 102 through the exit. The exit is covered by the upper cone 812 such that material is not able to fall directly into the exit.

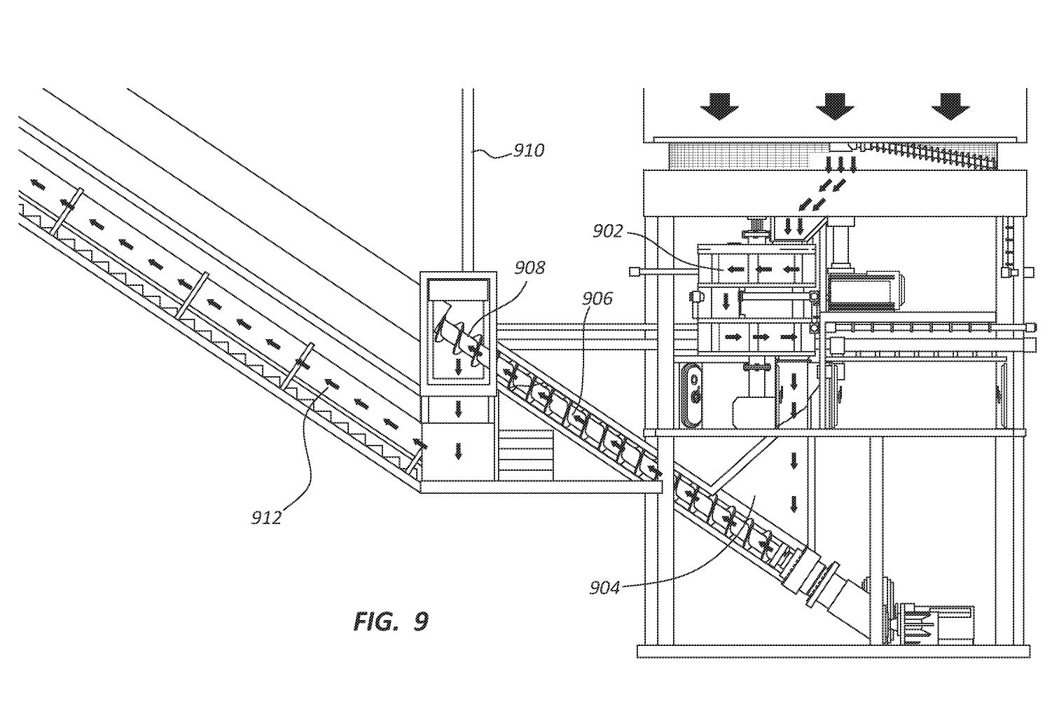

FIG. 9 illustrates a cross-section of the oil collector 804 below the floor assembly 114. The material that is swept by the auger 810 into the exit falls into a vapor sealed lock hopper 902 similar to the vapor sealed lock hopper assembly 300 of the feed system described previously. The vapor sealed lock hopper 902 inhibits gas from traveling up through the exit into the inner volume 112 of the retort structure 102.

The material falls from the vapor sealed lock hopper 902 into a quench chamber 904 filled with a cooling fluid, such as water. At the bottom of the quench chamber 904 an auger 906 transports material up out of the quench chamber 904. At a second end 908 of the auger 906 a steam collector 910 collects steam generated by the material interacting with the water of the quench chamber 904. At the second end 908 of the auger 906 the material drops onto an exit conveyer 912 for subsequent disposition.

The retort process will now be described in relation to the retort structure of the figures.

Returning to FIG. 1, the retort system 100 includes an energy source (not shown) for providing heat. One of ordinary skill in the art would recognize a number of techniques for supplying energy. In the embodiment of FIG. 1, the energy source heats a gas to a high temperature for injection through the nozzles 708 of the distribution system. The gas temperature of gas supplied to the second level 162 may be between 700 degrees Fahrenheit and 1500 degrees Fahrenheit. The heated gas may be inert such that it will not react with the material as the material is heated by the gas. In the embodiment of FIG. 1, the heated gas is delivered to the distribution system through a series of gas pipes 180.

Material is elevated by the elevator 132 to the horizontal top conveyor disposed in the conduit 134. The horizontal top conveyor conveys the material through the outer dome layer 150 and the inner dome layer 148. The material is fed into the inlet 308 of the vapor sealed lock hopper 300 and passes into the inner volume 112 of the retort structure 102.

The process of introducing the material into the inner volume 112 is continued until a live pile is formed within the retort structure. After a live pile is formed, the material may be introduced into the inner volume 112 at a varying rate depending on process needs. The material will form a series of piles atop the each of the tables 510 of the distribution system 106. The augers 202 disposed above the tables 510 rotate and may level the piles to form a substantially uniform distribution of material atop the tables 510.

As the material sits atop the tables 510, gas is injected through the pile of material at a controlled temperature. In the embodiment of FIG. 1, hot gas is injected in the distribution system at the second layer 160 to heat the material to an elevated temperature. The hot gas injected though the nozzles 708 will tend to rise through the pile heating the material above the table 510 in addition to the material immediate the nozzle 708. The material on the table 510 will remain on the table 510 until it is pushed off using the rake assembly 600.

The rake assembly 600 is actuated and moves the rake blades 602 across the upper surface of the table 510 pushing the material off of the table 510. The material falls to the next pile formed above the fourth level 166 of the distribution system 106. The frequency at which the rake assembly 600 is actuated is controlled to achieve a desired material flow rate. In some embodiments the rake assembly 600 may actuate at a set frequency, or in other embodiments a sensor may measure the temperature of the material atop the table 510 and actuate the rake assembly 600 when a set temperate is reached. The rate at which the material flows through the distribution system 106 can be increased by increasing the frequency at which the rake assembly 600 actuates and decreased by having the rake assembly 600 actuate less frequently. The rake assembly 600 may be in continual motion across the tables 510 or may rest at an edge of a table 510 between actuations.

As the material is heated, organic matter within the material undergoes pyrolysis in which the organic matter forms hydrocarbons. The types of hydrocarbons formed are dependent upon several factors including the pyrolysis temperature and the type of organic matter. In general, a higher processing temperature results in a lower API of hydrocarbons while a lower pyrolysis temperature results in a higher API of hydrocarbons. Liquid hydrocarbons that form will tend to fall by way of gravity to the bottom of the retort structure 102. Gaseous hydrocarbons are typically buoyant and tend to rise to the top of the retort structure 102 where they can be collected. Vapor recovery exit 27 pulls vapors 26 from the dome retort 9 into the recycle gas system leading to the condenser 28. The collected gaseous hydrocarbons can be burned to provide make up heat and may also serve as the heated gas that is injected through the nozzles to heat the material.

The material falls from the second level 162 of the distribution system 106 and forms a second pile atop the third level 166 of the distribution system 106. The second set of augers 202 rotate and distribute the heated material uniformly in the second pile. In the embodiment of FIG. 1, a second gas is injected at a second temperature that is lower than the first temperature cooling the material. The second temperature may cool the material below a pyrolysis temperature, or may hold the material at a pyrolysis temperature.

In a manner similar to the second level 162 of the distribution system 106, the material is raked off of the tables 510 and it falls to form a third pile just above the retort structure 102 floor assembly 114. The material is channeled into the collection system 800. Liquid hydrocarbons fall to the bottom of the material pile and flow by way of gravity down the conical surface 806 of the collection system 800. The baffles 812 on the conical surface 806 inhibit movement of the material down the conical surface 806, while the liquid hydrocarbons are able to flow past the baffles 812. At the perimeter 808 of the oil collection system 800, the liquid hydrocarbons drop into a collection trough where they can be transported to a holding vessel.

As the auger 810 rotates about the collection system 800, the auger 810 rotates about its axis pushing material toward the central cone 812. As the material flows along the auger 810 into the gap between the conical surface 806 and the central cone 812, the material falls into the exit vapor sealed lock hopper 902.

From the exit of the vapor sealed lock hopper 902 the material falls into the quench chamber 904. The residual heat of the material may vaporize a portion of the water in the quench chamber 904 generating steam. The vapor sealed lock hopper 902 inhibits the generated steam from exiting into the inner volume 112 of the retort structure 102. The steam may be collected by the steam collector 910 and used as a secondary energy source. The material falls through the quench chamber 904 to the bottom where the auger 906 transports the material to a conveyer where the spent material can be disposed.

Residence time of material within the retort system may include a time period of between a few minutes up to over 100 days, and retorting of the material is contemplated to be conducted at a temperature of from about 700° F. to about 1200° F. and, more specifically, between about 750° F. and 950° F.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of heating and conveying hydrocarbonaceous material in a retort structure comprising an internal volume, an outlet, a grate, a gas injector, and an auger, the method comprising:
introducing the hydrocarbonaceous material into the internal volume through the inlet, wherein the inlet substantially prevents gaseous transfer between the inner volume and the exterior of the retort structure;
passing the hydrocarbonaceous material through the grate;
injecting a gas heated to a first temperature through the gas injector to heat the hydrocarbonaceous material while the hydrocarbonaceous material is atop the grate;
collecting the hydrocarbonaceous material with the auger after the hydrocarbonaceous material has passed through the grate; and
removing the hydrocarbonaceous material collected by the auger through the outlet, wherein the outlet substantially prevents gaseous transfer between the inner volume and the exterior of the retort.

2. The method of claim 1, wherein passing the hydrocarbonaceous material through the grate comprises raking a top of the grate to push hydrocarbonaceous material into an open portion of the grate.

3. The method of claim 2, wherein the method further comprises distributing the hydrocarbonaceous material above the grate with a second auger.

4. The method of claim 2, wherein the method further comprises:
catching the hydrocarbonaceous material on the second grate after the hydrocarbonaceous material passes through the first grate; and passing the hydrocarbonaceous material through the second grate.

5. The method of claim 4, wherein the method further comprises injecting gas at a second temperature into the hydrocarbonaceous material atop the second grate.

6. The method of claim 1, wherein the hydrocarbonaceous material travels from the inlet through the grate and from the grate through the outlet through the force of gravity.

7. The method claim 4, wherein the method further comprises:
raking a top of the second grate pushing hydrocarbonaceous material into an open portion of the second grate.

8. A method of heating and conveying a hydrocarbonaceous material through a retort structure, the method comprising:
introducing the hydrocarbonaceous material through an inlet to the retort structure, wherein the inlet substantially prevents gaseous transfer from the an interior of the retort structure and an exterior of the retort structure;
forming a first pile of hydrocarbonaceous material atop a first grate;
injecting a first gas at a first temperature into the pile of hydrocarbonaceous material formed atop the first grate;
raking a lower portion of the first pile of hydrocarbonaceous material into an open portion of the first grate;
forming a second pile of the hydrocarbonaceous material atop a second grate, the second pile being comprised of hydrocarbonaceous material fallen through the first grate;
injecting a second gas at a second temperature into the second pile of hydrocarbonaceous material formed atop the second grate;
raking a lower portion of the second pile of hydrocarbonaceous material into an open portion of the second grate;
collecting the hydrocarbonaceous material fallen through the second grate with an auger; and
removing the hydrocarbonaceous material collected by the auger through the outlet, wherein the outlet inhibits gaseous transfer between the interior of the retort structure and its exterior.

9. The method of claim 8 wherein said first temperature is between 600 and 900 degrees Fahrenheit.

10. The method of claim 9 wherein said second temperature is between 220 and 400 degrees Fahrenheit.

11. The method of claim 10 wherein said second gas is steam.

12. The method of claim 8 wherein said hydrocarbonaceous material is introduced into the retort structure at a rate exceeding 25000 tons per day.

13. The method of claim 8 wherein said hydrocarbonaceous material is heated to a temperature less than 800 degrees Fahrenheit atop the first grid.

14. The method of claim 8 wherein the hydrocarbonaceous material is cooled to a temperature less than 300 degrees Fahrenheit.

15. The method of claim 8 wherein the method further comprises quenching the removed hydrocarbonaceous material in a quench chamber.

16. The method of claim 15 wherein quenching the removed hydrocarbonaceous material generates steam, the method further comprising:
collecting steam produced by the quenching of the removed hydrocarbonaceous material.

17. The method of claim 16 further comprising powering an auxiliary process with the steam.

18. The method of claim 8 further comprising preheating the hydrocarbonaceous material prior to introducing the hydrocarbonaceous material into the retort structure.

19. The method of claim 8 wherein the hydrocarbonaceous material is introduced through the inlet substantially continuously.
